(19) United States
(12) Patent Application Publication
(10) Pub. No.: US 2009/0109387 A1
(43) Pub. Date: Apr. 30, 2009

(54) LIQUID CRYSTAL OPTICAL DEVICE MANUFACTURING PROCESS

(75) Inventors: Akira Sakai, Kawasaki-shi (JP); Hirokatsu Miyata, Hadano-shi (JP); Yasufumi Asao, Atsugi-shi (JP); Yohei Ishida, Kawasaki-shi (JP); Philip J. Martin, West Lindfield (AU); Avi Bendavid, West Lindfield (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/295,692

(22) PCT Filed: Nov. 29, 2007
(86) PCT No.: PCT/JP2007/073531

§ 371 Date: Oct. 1, 2008

(30) Foreign Application Priority Data
Dec. 8, 2006 (JP) 2006-332173

(51) Int. Cl. G02F 1/1337

(52) U.S. Cl. 349/124

(57) ABSTRACT

A manufacturing method of a liquid crystal optical device is provided including an alignment film forming step of forming an alignment film containing silicon oxide on a substrate, and a liquid crystal cell forming step of disposing a pair of substrates at least one of which the alignment film has been formed on, opposite to each other interposing a liquid crystal therebetween. In the alignment film forming step, the substrate surface is bombarded with a plasma beam generated by vacuum arc discharge using a cathode containing silicon, where the substrate is disposed on the course of the plasma beam obliquely with an angle. When the plasma beam bombards the substrate surface, plasma ions in the plasma beam have higher kinetic energy or higher flux density than plasma ions in a plasma beam which, if bombarding the substrate obliquely at the angle, form a film having a column structure.

### TECHNICAL FIELD

This invention relates to a process for manufacturing a liquid crystal optical device, and more particularly to a process for manufacturing a liquid crystal optical device having an inorganic alignment film.

### BACKGROUND ART

Optical devices which contain liquid crystals, such as liquid crystal display devices and liquid crystal light valves, each consist basically of a pair of substrates disposed opposite to each other and a liquid crystal interposed between them. Voltage is applied to an electrode(s) provided on one or both of the substrates, whereby the state of alignment of liquid crystal molecules is changed and the optical properties such as birefringence (double refraction) and optical rotary power can be controlled.

An alignment film for aligning liquid crystal molecules is formed on at least one of the substrates. When no voltage is applied, the directions of liquid crystal molecules are regulated by the alignment film. As a method of forming the alignment film, a rubbing method is most typical in which a polymer film is formed on the substrate by coating and its surface is rubbed in one direction. This rubbing method enables liquid crystal molecules to be uniformly aligned to the substrate having a large area, and hence is suitable for forming the alignment film on a large-area substrate. A polymer film material most widely used in the rubbing method is polyimide. The polyimide has a high durability to light or temperature variations in environments used in usual displays.

However, in liquid crystal display devices used as light shutters of projection type displays, the liquid crystal is exposed to strong light, and hence the high-molecular film tends to deteriorate and can not be expected to have a high durability. Even in a polyimide alignment film which is chemically more stable than other polymer molecules, its chemical structure is broken down due to exposure to strong light and it cannot withstand long-time service. To solve this problem, Japanese Patent Application Laid-Open No. 2000-284287 proposes a liquid crystal device which is provided with an optical filter of the same material as that of an alignment film. Japanese Patent Application Laid-open No. 2001-042335 discloses a liquid crystal display device in which a polyimide having an aromatic ring concentration of 0 to 3% is used to reduce the absorbance of an alignment film.

Besides such a polymer film rubbing method, a method is also well-known in which a microstructure is formed on the substrate surface by using an inorganic material to cause anisotropy. A typical type of method is what is called an oblique deposition method in which silicon monoxide or silicon dioxide is deposited obliquely to a substrate. Japanese Patent Application Laid-Open No. 2003-129228 discloses an example in which a three-panel type liquid crystal projector is constituted of a liquid crystal light valve using an oblique deposition film.

The film formed by oblique deposition has a structure in which, when observed on an electron microscope, slender crystals of several nanometers in diameter congregate obliquely on a substrate. Columns are distinguishable one by one, and substantially connect with one another in the layer thickness direction. It is evident that such columns are those having grown uniformly in the height direction in the course of forming the film. Such structure is hereinafter called a column structure.

The alignment direction of liquid crystal molecules is controlled by column inclination. As for the characteristics of such columns, inorganic matter such as silica has higher chemical stability and better durability to light than organic matter. Accordingly, the oblique vacuum deposition method is being realized again as a method for forming alignment films of liquid crystal display devices used for projectors.

In the oblique deposition method, the angle of deposition must precisely be set, and hence the deposition source is made as small as possible so that deposition materials can be discharged from substantially a single point. Hence, where vacuum deposition materials are to be deposited on the whole surface of a broad substrate, differences come about in the flying direction at every position of the substrate that receives the deposition materials, so that the inclination angles and directions of columns may be distributed on the substrate.

FIG. 2A illustrates a case of the oblique deposition, where particles are emitted from a point source. FIG. 2B shows a case for comparison in which a substrate is bombarded with parallel beams.

As long as the bombardment with parallel beams as shown in FIG. 2B can be realized, the incidence angles θ1 and θ2 at both ends of the substrate become equal and also the incidence azimuth is constant.

However, in the case shown in FIGS. 2A and 2B in which the oblique deposition is carried out using a point source for deposition, the incidence angles θ1 and θ2 at both ends of the substrate are distributed within this range. On one straight line perpendicular to the drawing sheet surface, the angle of incidence is constant but the azimuth differs in which deposition beams come flying.

Thus, in the deposition using a point source, the inclination angle of columns (an angle with respect to a normal line of the substrate) becomes distributed. The azimuth angle of columns also becomes distributed in the in-plane direction. The inclination angle and azimuth angle of the columns directly determine the alignment of liquid crystal molecules, and hence their non-uniformity brings about substrate in-plane alignment non-uniformity. This results in substrate in-plane distribution of the alignment of liquid crystal molecules. Especially when the incidence angle is large, the deviation of the incidence angle by only 0.1° creates a great change in the angle of liquid crystal molecules to the substrate surface (hereinafter referred to as “pretilt angle”).

It is common for small-sized liquid crystal display devices such as the light valves of projection type displays that the alignment film is formed on a large-area substrate and thereafter is cut into desired sizes. In this case, since the deposition angle should be constant in individual devices, non-uniformity over the whole substrate may be tolerable to a certain extent. However, when two substrate with an alignment film formed therebetween are joined together, there are difficulties such that characteristics are not uniform between liquid crystal display devices which have been divided, because the differences in deposition angles between the upper and lower alignment film occur in the vicinity of the substrate ends and such differences are changed depending on positions.

Such non-uniform characteristics may result in such an inconvenience that when used as light valves of projection type displays, the optical axes and electrical responses of the light valves differ for each device, and projection optical systems must be adjusted for individual devices.

### DISCLOSURE OF THE INVENTION

The present invention has been made taking the above problems into account, and is a manufacturing method of a liquid crystal optical device, comprising:

an alignment film forming step of forming an alignment film containing silicon oxide on a substrate, and a liquid crystal cell forming step of disposing a pair of substrates, at least one of which the alignment film has been formed on, opposite to each other interposing a liquid crystal therebetween, wherein

the alignment film forming step comprises a step of generating a plasma beam by vacuum arc discharge using a material containing silicon as a cathode, and a step of bombarding with the plasma beam a surface of the substrate which is disposed on a course of the plasma beam obliquely with an angle; and

in the step of bombarding the surface of the substrate, plasma ions in the plasma beam have higher kinetic energy or higher flux density than plasma ions in a plasma beam which, if bombarding the substrate obliquely with the angle, form a film having a column structure.

According to the process of the present invention, a liquid crystal alignment film formed of an inorganic material having excellent durability can be manufactured uniformly over a large area and at a high deposition rate.

Further features of the present invention will become apparent from the following description of exemplary embodiments with reference to the attached drawings.

### BRIEF DESCRIPTION OF THE DRAWINGS

FIG. 1 illustrates a film forming system used in the manufacturing process of the present invention.

FIGS. 2A and 2B illustrate the difference in distribution of the bombardment directions between a conventional vacuum deposition method (FIG. 2A) and the manufacturing process of the present invention (FIG. 2B).

FIG. 3 diagrammatically illustrates the constitution of a liquid crystal display device.

FIGS. 4A, 4B, 4C and 4D illustrate the alignment state of crystal molecules.

FIGS. 5A and 5B are a plane view (FIG. 5A) and a side view (FIG. 5B) which show the arrangement of substrates in Example 1 of the present invention.

FIG. 6 illustrates the arrangement of electromagnets for plasma beam scanning used in the manufacturing process of the present invention.

FIG. 7 illustrates how to measure the pretilt angle.

FIG. 8 is a graph showing the measurement results of the pretilt angle in liquid crystal alignment.

FIGS. 9A and 9B are sectional SEM photographs of an alignment film formed by the manufacturing process of the present invention (FIG. 9A) and an alignment film formed by conventional oblique deposition (FIG. 9B).

FIG. 10 is a graph showing the XPS measurement results of alignment films formed in Example 2 of the present invention.

FIG. 11 is a graph showing the measurement results of refractive indexes of alignment films formed in Example 2 of the present invention.

FIG. 12 is a graph showing the measurement results of the relationship between the plasma bombardment angles and pretilt angles of alignment films formed in Example 2 of the present invention.

FIG. 13 is a graph showing the azimuth dependence of transmittance of a liquid crystal display device formed according to Example 2 of the present invention.

FIG. 14 is a graph showing the voltage dependence of transmittance of the liquid crystal display device formed in Example 2 of the present invention.

### BEST MODE FOR CARRYING OUT THE INVENTION

In ion implantation, ion etching, etc. used in fabricating semiconductor devices, parallel ion beams are in wide use. U.S. Pat. No. 5,433,836 discloses a method in which the orbit of a plasma beam generated by arc discharge is curved with magnetic fields, in the course of which large-mass particles (droplets) are removed to form a uniform, parallel ion plasma beam (a filtered arc deposition method; hereinafter referred to as “FAD method”).

As stated already, inorganic alignment films have durability superior to organic alignment films subjected to rubbing treatment. Inorganic alignment films produced by the FAD method have not only such an advantage, but also three advantages roughly grouped as stated below, as compared with inorganic alignment films produced by the conventional oblique deposition method.

The first advantage is that since ions in a plasma beam are parallel, differently from the deposition carried out using a point deposition source, the incidence angle and incidence azimuth of particles can be kept constant without regard to the position of a substrate.

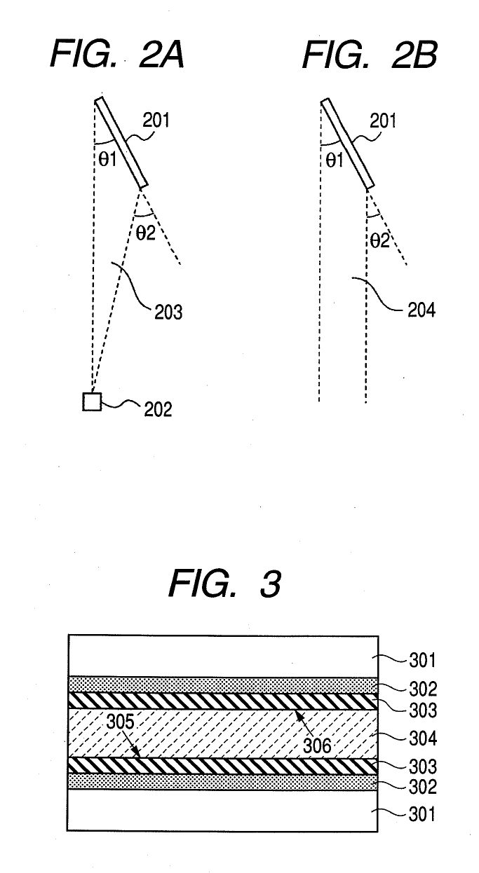

In the conventional oblique deposition, as shown in FIG. 2A, the angle at which deposition beams 203 reach a substrate 201 scatters depending on the distance from a vacuum deposition source 202. On the other hand, a plasma beam 204 produced from arc plasma and whose directions are adjusted to be uniform by the aid of magnetic fields, are substantially parallel as shown in FIG. 2B. The incidence angles θ1 and θ2 at both ends of the substrate are equal and the incidence azimuth is substantially uniform over the whole substrate.

The second advantage is that the rate of film formation is high. Vacuum arc plasma sources can generate plasma in a large quantity by effecting arc discharge at a large electric current. As a result, high flux density of ions is achieved in the plasma beam to increase the rate of film formation. This leads directly to the achievement of large throughput, and hence is a great advantage in view of productivity.

The third advantage is that the film surface is smooth because no column is formed. In the FAD method described below, since large-mass particles are removed from the plasma beam, the film can have much higher surface smoothness. As a result, alignment defects and non-uniformity of liquid crystal molecules due to film unevenness can be kept from occurring. The surface smoothness also acts effectively in reducing the mutual action between the liquid crystal and the alignment film surface.

According to studies made by the present inventors, the liquid crystal formed by the FAD method additionally has the following characteristics.

In the conventional oblique deposition method, a deposition source is heated by resistance or irradiation with electron rays to generate the vapor of deposition materials. The deposition source is set at a temperature of from 700° C. to 1,000° C., and the kinetic energy of vacuum deposition particles having come into vapor is on the order of the heat energy produced at the temperature of the vacuum deposition source, which is 0.1 eV at most.

On the other hand, the kinetic energy of plasma ions in the FAD method is typically tens of eV, which is two-digit or more higher than that of the vapor in the oblique deposition. Where a substrate is bombarded with plasma ions having such high kinetic energy, the plasma ions vigorously move around the substrate to easily break even if the columns have been formed. Thus, it is supposed that any columns can not be formed after all.

In addition, the FAD method can make plasma beams have higher flux density than the oblique deposition method. The flux density herein referred to means the number of particles passing through a unit area perpendicular to the plasma beams per unit time. When the number of particles which reach the substrate per unit time is high, it is supposed that there is a high probability that the particles reach the gaps between individual columns, and the gaps between the columns are easily buried.

However, an experiment made by the present inventors has revealed that the film obtained by obliquely bombarding the substrate with high-energy and high-density plasma ions present in the plasma beam produced by the FAD method has, even though no columns are certainly formed, the property to substantially uniformly align liquid crystal molecules. It has also been ascertained that the alignment of liquid crystal molecules is substantially perpendicular to the substrate, and as the liquid crystal molecules are inclined by applying a voltage, the liquid crystal molecules are inclined in the inclination plane including the direction of bombardment with the plasma beam.

This indicates that the film obtained has, though columns are not observed, certain directionality depending on the direction of bombardment with plasma beam.

The film obtained by the present invention is considered to have much finer structure unobservable with an electron microscope. In any case, it is characteristic of the present invention that any usual column structure observable with an electron microscope is not observed.

Liquid crystals that are substantially in vertical alignment when no voltage is applied and in inclined alignment when voltage is applied, are known as those of a VA (vertical alignment) mode. The film formation carried out by oblique bombardment with plasma beam according to the present invention can be said to be suitable for the formation of VA mode liquid crystal display devices.

The plasma beams in the FAD method are high in parallelism and constant in incidence angle and azimuth over the large area of the substrate. Besides, the properties of conventional oblique deposition films, i.e., the vertical alignment performance and in-plane anisotropy are maintained in the film forming method in the present invention although no columns are formed. Thus, the present invention takes advantages of the conventional oblique deposition films in respect of the alignment of liquid crystal molecules and also can materialize these uniformly over the large area of the substrate.

### Vacuum Arc Plasma Film Formation

The step of forming the alignment film by using the FAD method is described below in detail.

The liquid crystal alignment film of the present invention is formed by a method in which a substrate is bombarded with a plasma beam generated by vacuum arc discharge to form a thin film on the substrate, in particular, a filtered arc deposition (FAD) method disclosed in U.S. Pat. No. 5,433,836.

The FAD method is a method in which plasma ions are generated from a cathode by vacuum arc discharge. The direction of the ion is curved with magnetic fields to form a plasma beam good in directivity. If the plasma ions bombard a substrate, a uniform film is formed on the substrate. This method is advantageous in that the plasma ions generated have large kinetic energy and the plasma is obtainable in a large quantity. Because of a high rate of film formation, the step of forming alignment films in this method is high in throughput, thus it is predominant in industry as well.

A cathode material is ionized at the cathode by arc discharge to generate plasma (also called arc plasma) which is a mixture of electrons and ions. The plasma obtained actually by arc discharge contains the monovalent or polyvalent positive ions and negative electrons the kinetic energy of which is mostly distributed within the range of from 20 eV to 100 eV.

Ions and electrons shoot out from the cathode surface and head for the anode. The positive potential of from 20 to 30 V with respect to the cathode is applied to the anode, where ions having larger kinetic energy than that leap over the potential barrier of the anode and are released into a plasma duct. In the duct, the ions undergo the action of convergence by the aid of magnetic fields to come into a substantially parallel plasma beam.

Thus, even without applying external force, the ions are taken out of the space where the arc discharge is taking place. The kinetic energy of plasma particles shooting out from the cathode surface is fixed in the course of the ionization at the cathode surface, and depends on the material that forms the cathode.

The plasma thus formed entirely differs in behavior from pure ion beams or electron beams. The magnetic field for polarizing the ion beams or electron beams must be precisely designed, and a strong magnetic field is often required. On the other hand, the plasma beam can easily be polarized with a weak magnetic field. This is because the orbits of electrons are first curved with magnetic fields, and the positive ions follow such electrons. This is called a “plasma streaming effect”.

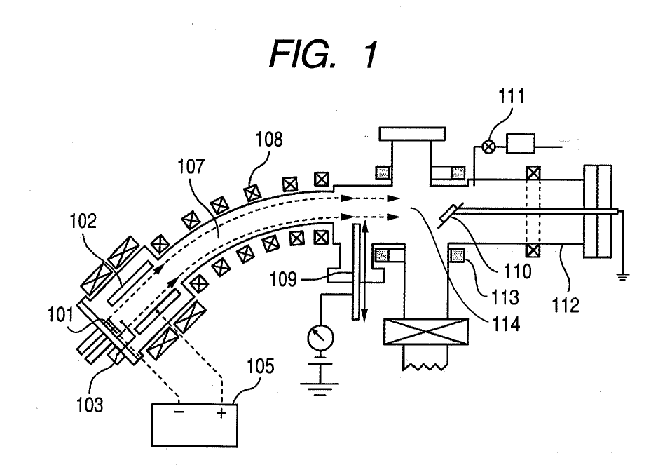

FIG. 1 is a diagrammatic view of a vacuum arc plasma film forming system used in the step of forming liquid crystal alignment films according to the present invention.

A cathode constituent material is made up of conductive materials such as silicon and aluminum. Here, an alloy of aluminum and silicon is used which are in a compositional ratio of 8:2.

A trigger electrode 103 is supplied with voltage from an arc electrode 105 to induce an arc between the electrode and a cathode 101. The trigger electrode 103 is temporarily brought into contact with the surface of the cathode 101 and then separated therefrom, whereupon electric sparks are generated between the cathode 101 and the trigger electrode 103. The electric sparks decrease the electrical resistance between the cathode 101 and the trigger electrode 103, so that a vacuum arc comes about. Usually, a DC arc is used. A pulse arc may also favorably be used.

An anode 102 is a cylindrical electrode. A positive voltage of 20 to 30 V is applied across the anode and the cathode. Ions shot out of the cathode have a larger energy than the voltage applied, and hence the anode allows the greater part of positive ions to pass.

The electrons and ions in the arc plasma pass through the anode electrode 102 to come into a plasma beam, which are then guided to a plasma duct 107. The plasma duct 107 is provided with toroidal coils 108 which generate magnetic fields, and the magnetic fields are formed along the direction of the duct. The orbit of the plasma beam is curved with the magnetic fields, and guided to a substrate 110 placed in a film forming chamber 114.

Usually, in the arc discharge, not only plasma of the materials constituting the cathode but also particles having a relatively large size which are called droplets are generated, and when they are deposited on the substrate surface, uniform film formation is inhibited. In the vacuum arc plasma film forming system shown in FIG. 1, the course of plasma is curved with the magnetic fields the toroidal coils 108 generate, to guide the plasma beam to the substrate, and hence, during which droplets having a large mass swerve from the course and do not reach the substrate 110.

The film forming method disclosed in U.S. Pat. No. 5,433,836 is called a filtered arc deposition method (FAD method) which comes from the fact that, as stated above, the course of the plasma beam is curved with magnetic fields to remove the droplets.

The flows of plasma generated from the cathode 101 are improved in directivity inside the curved plasma duct 107 to become substantially parallel, and guided to the film forming chamber 114. In the film forming chamber 114, the substrate 110 for film formation is placed in such a way that its film formation surface is oblique to the direction of the course of plasma, and is bombarded with the plasma beam from the oblique direction. The substrate 110 is inserted into the film forming chamber 114 through a load lock mechanism 112. After the film has been formed, a shutter 109 is closed, where the substrate is taken out of the film forming chamber 114.

Not silicon or aluminum itself but an oxide thereof is used as a material for the liquid crystal alignment film. In the present invention, oxygen gas is introduced into the film forming chamber 114, and the substrate is bombarded with the plasma beam in the presence of the oxygen gas to thereby form a film of silicon or aluminum oxide. A gas feed valve 111 is opened to introduce the oxygen gas through a gas feed channel, and the oxygen gas is allowed to react with ions inside the film forming chamber 114 to effect oxidation. The gas flow rate determines the stoichiometric composition of the film to be formed. The introduction of oxygen gas can control the energy of ion beams to a certain extent.

A direct current, RF or pulse type substrate bias voltage may be applied to the substrate 110, whereby the velocity of ions reaching the film can be controlled.

The diameter of the plasma beam depends on the size of the cathode. The flux density of the plasma beam, i.e., the flow rate per unit area in the plane perpendicular to the beam has in-plane distribution, which is higher in density at the center of the beams. Accordingly, some layer thickness distribution come about even though the direction of deposition is kept constant.

The layer thickness distribution affects not only the alignment of liquid crystal molecules, but also liquid crystal driving performance, and hence must be kept as small as possible. According to experiments made by the present inventors, scanning the substrate with the plasma beam is effective in forming the film uniform in thickness. In the film forming system shown in FIG. 1, two sets of electromagnets 113 are placed at the entrance of the film forming chamber 114 to form a magnetic field perpendicular to the direction of travel of the plasma beam, and these are so moved with time as to shift the orbits of the plasma beam to scan the substrate with the plasma beam.

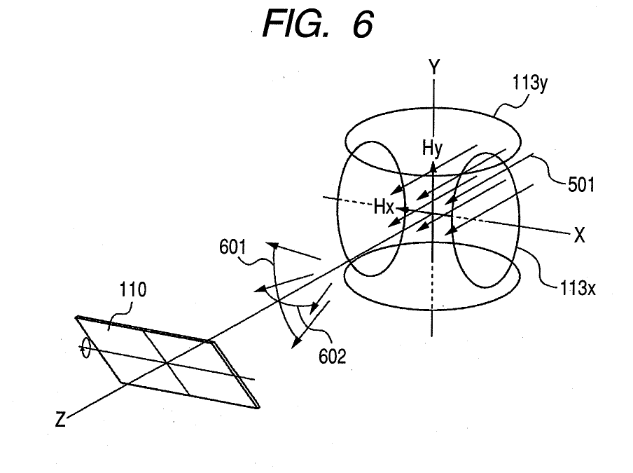

FIG. 6 is a diagrammatic structural view of how the electromagnets 113 are disposed. Note that the plasma beam 501 are emitted in the direction of Z, a magnetic field Hx in the direction of X is formed by a coil 113x, and a magnetic field Hy in the direction of Y is formed by a coil 113y.

The passing plasma beam is deflected in the direction of X within a certain range 602 by varying the magnetic field Hx in an alternating-current fashion, and at the same time, deflected in the direction of Y within a certain range 601 by varying the magnetic field Hy in an alternating-current fashion. The electric currents flowing through the coils 113x and 113y can be controlled to change the frequency and amplitude of beam scanning.

### Manufacture of Liquid Crystal Cell

A liquid crystal cell forming step of forming a liquid crystal cell from the substrates prepared as above is described below. In the production of a liquid crystal display device, substrates with electrodes formed thereon are used. In the case of transmission type liquid crystal displays, alignment films are formed on a pair of transparent glass substrates on which electrodes made of indium-tin oxide (ITO) have been formed. In the case of reflection type liquid crystal displays, a transparent glass substrate on which the same electrode as in the above has been formed may be used as one substrate, and a silicon substrate on which a reflecting electrode made of a material such as aluminum has been formed may be used as the other substrate. Alignment films are formed on these substrates by the FAD method, and the two substrates are joined together to form a liquid crystal cell.

FIG. 3 is a diagrammatic sectional view of a liquid crystal cell of the present embodiment.

In FIG. 3, reference numerals 301's denote glass substrates; 302's, ITO transparent electrode films; 303, alignment films; and 304, a liquid crystal layer. The alignment films 303 are formed using an inorganic material by the FAD method.

The alignment films on the substrates are formed by bombardment with the plasma beam in the directions shown by arrows 305 and 306, respectively. In the liquid crystal cell shown in FIG. 3, two substrates are joined together so that the directions of bombardment with the plasma beam are antiparallel to each other. The distance between the substrates is kept constant with a spacer (not shown). A liquid crystal material whose dielectric anisotropy is negative is selected as the liquid crystal to be filled in the cell.

In OCB (optically compensated bend) alignment, two substrates are joined together so that the directions of bombardment with the plasma beam are parallel to each other.

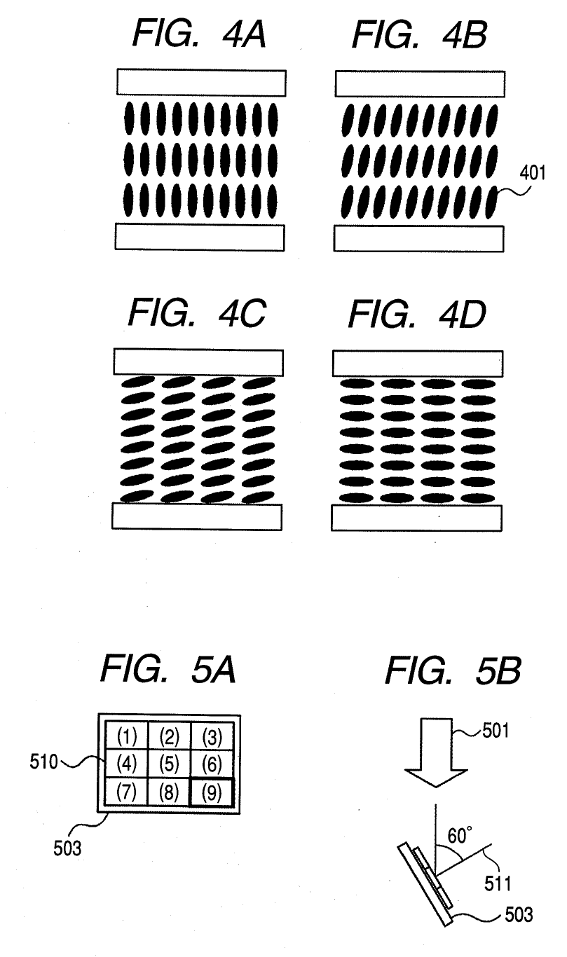

FIGS. 4A to 4D diagrammatically illustrate types of typical liquid crystal alignment.

FIG. 4A shows completely vertical alignment, where liquid crystal molecules are aligned so that their long axes are vertical to the substrate.

FIG. 4B shows vertical alignment with a pretilt angle, where liquid crystal molecules are aligned so that their long axes are inclined at a certain angle to the normal direction of the substrate.

FIG. 4C shows horizontal alignment with a pretilt angle, where liquid crystal molecules are aligned so that their long axes rise at a certain angle from the substrate surface.

FIG. 4D shows completely horizontal alignment, where liquid crystal molecules are aligned so that they are completely parallel to the substrate surface.

The liquid crystal alignment film obtained by using the FAD method is of the type shown in FIG. 4B. As described below, the inclination angle of liquid crystal molecules to the normal of the substrate (herein called “pretilt angle”) is several degrees at most. Upon applying voltage, the liquid crystal molecules become gradually inclined, and as they are inclined, the transmittance increases. The inclination azimuth can be known from the extinction position under crossed Nicols.

The pretilt angle may be measured by the known crystal rotation method using a cell of 10 μm to 20 μm in cell thickness which has been prepared separately from the production of liquid crystal display devices.

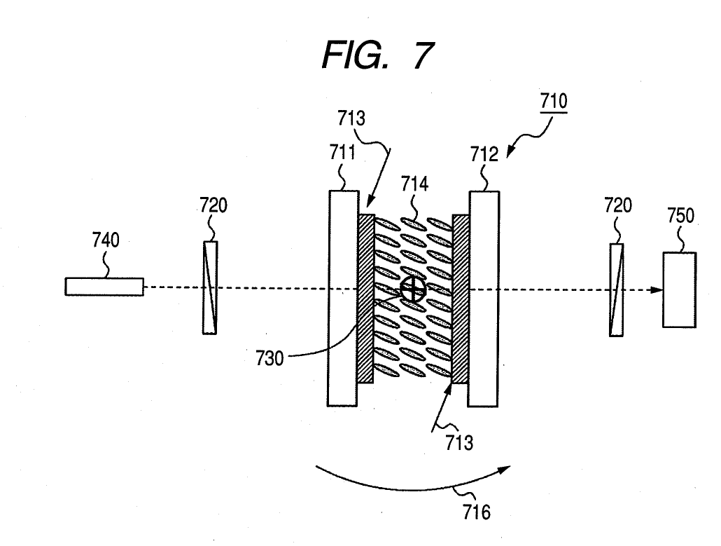

FIG. 7 illustrates the principle of measuring the pretilt angle by the crystal rotation method.

A liquid crystal cell 710 for measuring the pretilt angle is one in which two substrates 711 and 712 are joined together so that their the incident directions 713's of the plasma beam are opposite to each other, and then a liquid crystal 714 is injected. The molecules of the liquid crystal 714 are aligned obliquely to the normal of the substrates 711 and 712. The inclination azimuth of liquid crystal molecules in the plane of the substrate is substantially in agreement with the incidence azimuth of the plasma beam. FIG. 7 is drawn so that these azimuths are in-plane in the drawing sheet.

This cell 710 is placed between a pair of polarizers 720. The polarizers 720 are set so that the absorption axis of one polarizer is at an angle of 45° to the inclination azimuth of liquid crystal molecules. The liquid crystal cell 710 is irradiated with light emitted from a light source 740 while being rotated around an axis 730 perpendicular to the drawing sheet surface, and the intensity of transmitted light is measured with a light receptor 750.

The liquid crystal molecules are aligned obliquely to the substrate, and hence, as the liquid crystal cell 710 is rotated, the transmittance becomes minimum at a certain angle. This angle is an angle at which the direction of travel of light in the interior of the liquid crystal cell has come into agreement with the directions of long axes of liquid crystal molecules, i.e., accurately, the direction of a director to which the molecular long axes are parallel on average. The pretilt angle can be found from this angle and the reflectance of the substrate.

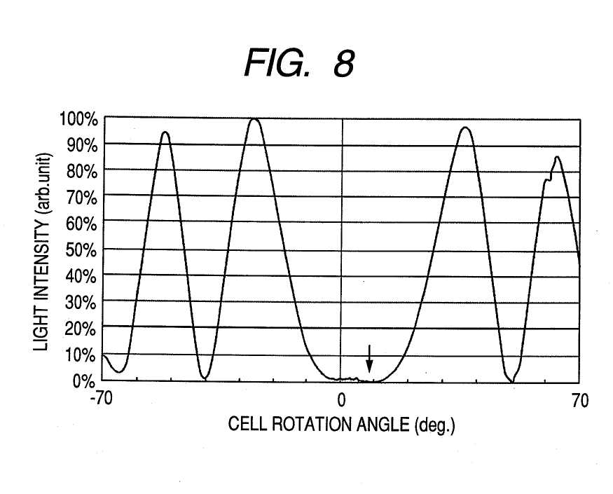

An example of the results is shown in FIG. 8. The example shown in FIG. 8 is directed to a cell in which the bombardment with the plasma beam is at an angle of 60°.

In FIG. 8, the abscissa represents the rotation angle of the liquid crystal cell, and the ordinate represents the transmittance. The cell rotation angle is plotted as positive in respect of the direction shown by reference numeral 716 in FIG. 7, i.e., the same direction as the moment the vectors of the incident directions 713's of the plasma beam have with respect to the axis 730. The substrate normal direction is set to be 0°.

The intensity of transmitted light comes minimum when the alignment direction of liquid crystal molecules, i.e., the average direction of liquid crystal molecules comes into agreement with the direction of light transmitted through the cell. The intensity of transmitted light is minimum at the position shown by an arrow (the cell rotation angle is +8.8°). The pretilt angle found from this has been found to be 3.5°.

According to experiments, with alignment films obtained by the FAD method, the pretilt angle of liquid crystal molecules always takes a positive value. That is, the azimuth of inclined liquid crystal molecules in the plane of the substrate is in the direction of the in-plane component of the bombardment vector of the plasma beam. In other words, the liquid crystal molecules are inclined toward the side opposite to the direction of bombardment with the plasma beam (the direction in which the plasma beam come as viewed from the substrate) with respect to the normal of the substrate.

Columns inclined toward the direction of deposition are formed in the alignment film obtained by oblique deposition, where the liquid crystal molecules are inclined toward the side opposite to the columns. Thus, the relationship between the direction of the plasma beam bombardment in the alignment film in the present invention and the inclination of liquid crystal molecules is the same as the relationship between the directions of deposition in the conventional oblique deposition.

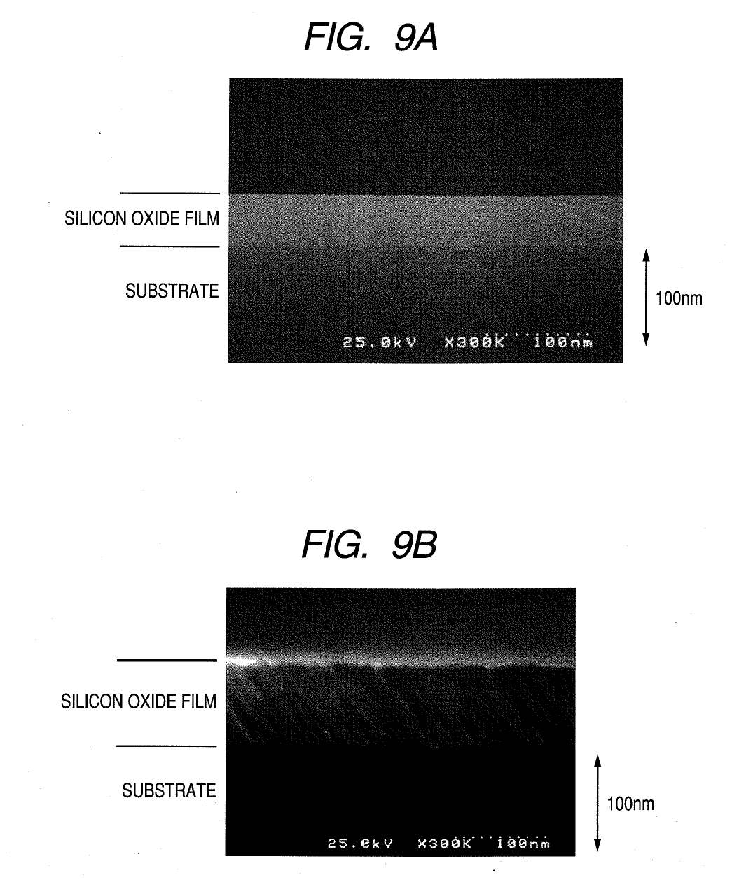

FIG. 9A shows a cross section of an alignment film formed in the process of the present invention, observed with a scanning electron microscope. For comparison, a cross section of an alignment film formed by the conventional oblique deposition is shown in FIG. 9B.

In the alignment film formed according to the present invention, any column is not seen so far as the alignment film is observed at least with the electron microscope. The reason why any column is not formed or observed is unclear, but is presumed as follows: In the FAD method, the energy of plasma ions is one-digit to two-digit higher than the energy of particles in the oblique vacuum deposition, and plasma particles have kinetic energy left to a certain extent even after they have reached the substrate, to move around on the substrate. As a result, they are considered to bury the gaps between columns. Alternatively, it is presumed that the flux density of bombardment with the plasma beam in the FAD method is larger than the density of bombardment with particles in the oblique deposition and hence masking structures as in the columns are not formed from the beginning.

In any case, it is characteristic of the alignment film formation by the FAD method that in spite of a film in which no column is formed, the inclined alignment of liquid crystal molecules close to the vertical alignment as in the oblique deposition can be achieved. When producing liquid crystal display devices by the use of the alignment film obtained by the FAD method, it is possible to eliminate non-uniformity in the deposition angle and vacuum deposition direction that has been unavoidable in the oblique deposition.

### Application To Liquid Crystal Projector

As stated above, the FAD method can form alignment films which are uniform over a wide range.

Where two substrates with alignment films formed thereon are produced under the same conditions and joined together, the deposition angle and the alignment azimuth are not deviated depending on the differences in positions between the two substrates. Therefore, the liquid crystal display device obtained can have uniform characteristics at every place. When this is cut and separated into small-size cells, every small cell is consistent in characteristics.

Where a substrate with an alignment film formed thereon is divided into small pieces before the substrate is joined with another substrate, and thereafter the divided substrates are joined together to make cells, it is unnecessary to sort out pairs to be joined, in accordance with their positions on the original substrates. Accordingly, the divided substrates can be used as substrates of liquid crystal cells without rendering any positions on the original substrates useless.

All the liquid crystal cells thus completed have uniform alignment and are also uniform in the inclination direction of liquid crystal molecules, and hence it is unnecessary to adjust optical devices for each device when the liquid crystal cells are set in optical devices and used. Further, where any three of the liquid crystal cells are combined together to form a three-panel type liquid crystal projector, color tones do not become uneven depending on cell devices because three light valves have uniform characteristics.

The present invention is more specifically described below by way of working examples.

### EXAMPLE 1

An inorganic alignment film was formed on glass substrates by means of the vacuum arc plasma film forming system shown in FIG. 1.

An alloy of 92% of silicon and 8% of aluminum was used as a material for the cathode 101. Oxygen gas was fed into the film forming chamber 114 to form an inorganic alignment film composed of Al₂O₃ and SiO₂.

The substrate used was an alkali-free glass substrate of 0.7 mm in thickness. On the surface of the substrate, an ITO film was formed in a thickness of 20 nm. This substrate was cut in a size of 20 mm square to prepare film-formed glass substrates 510.

The arrangement of the glass substrates 510 at the time the alignment film was formed is shown in FIGS. 5A and 5B. Nine sheets of the film-formed glass substrates 510 were arranged as shown therein and were held in a substrate holder 503. This holder with substrates was set in the vacuum arc plasma film forming system shown in FIG. 1, in such a way that the direction of the substrate normal 511 was at an angle of 60° to the direction of the plasma beam 501.

As the substrate 110 in FIG. 1, the above nine substrates 510 were set in a load lock chamber 112, and thereafter the interior of the film forming chamber 114 was evacuated. After the interior of the system reached sufficient vacuum, the substrates were bombarded with the plasma beam to form the alignment film thereon. The arc plasma was operated under the conditions of a voltage of 30 V and an electric current of 120 A to produce a plasma electric current of about 300 mA which was based on mixed cations of aluminum and silicon. Oxygen was also fed onto the substrates at a flow rate of 6 sccm so as to deposit Al₂O₃ and SiO₂. In this case, the oxygen partial pressure in the system was 1.0 Pa.

At the time of film formation, two-dimensional scanning with the plasma beam was effected in order to improve the uniformity of deposition. This was achieved by providing as shown diagrammatically in FIG. 1 the two sets of electromagnets 113 at the entrance of the film forming chamber 114 extending from the plasma duct 107, and by flowing an electric current through coils of the electromagnets. In this Example, both a coil for scanning in the up-and-down direction and a coil for scanning in the right-and-left direction were used to effect the two-dimensional scanning. An electric current of 50 Hz was flowed through the coils to effect the beam scanning.

Under the above conditions, the vacuum deposition was carried out for 30 seconds, and thereafter the substrates with a film formed thereon were taken out of the system. From the observation of the cross section of this film on a scanning electron microscope, the layer thickness was found to be 200 nm. The rate of film formation was 400 nm/min. This rate is one-digit higher than the rate of vacuum deposition (several tens of nm/min) in the case where silicon oxide is deposited by the conventional oblique deposition using electron beams. Therefore, it follows that the surface density of particles with which the substrate surface has been bombarded per unit time is one-digit higher than that in the oblique deposition.

Two substrates with alignment films formed thereon, which were taken out of the nine substrates on each of which the alignment film had been formed as described above, were placed face to face so that the directions of bombardment with plasma beams were antiparallel to each other. Then, these two substrates were joined together by using a sealing agent containing silica beads of 3.0 microns in size. After that, these were bombarded with ultraviolet light to cure the sealing agent. Thus a hollow cell was prepared.

Next, a liquid crystal was injected into this cell. The liquid crystal used was MLC-6608, available from Merck & Co., Inc. This liquid crystal exhibits substantially vertical alignment on a conventional silica oblique deposition film. To inject the liquid crystal into the cell, the cell was held in a vacuum chamber and, after deaeration, the liquid crystal was applied to a liquid crystal injection opening of the cell, then the pressure inside the vacuum chamber was gradually returned to the atmospheric pressure. After the liquid crystal was injected, the injection opening was sealed, and the liquid crystal cell thus obtained was used for measurement.

The cell into which the liquid crystal had been injected was placed between two polarizing plates disposed in the state of crossed Nicols to make an observation. This liquid crystal cell was seen to hardly transmit light without regard to the polarization axial direction of the polarizing plates. Thus, the liquid crystal molecules are aligned substantially vertically to the substrate. Faulty alignment was not observed by the naked eye. Microscopic observation was further made and revealed that a uniform state of alignment was achieved even in minute regions.

For a liquid crystal cell with the same alignment film as in the above, the pretilt angle was measured in the same way as shown in FIG. 7, and found to be about 4°.

Lead wires were attached to the upper and lower electrodes of the liquid crystal cell, and the liquid crystal cell was placed between two polarizing plates disposed in the state of crossed Nicols, to examine the dependence of transmittance on applied voltage. The liquid crystal cell was placed so that the direction in which liquid crystal molecules are inclined from the vertical direction came into agreement with the polarization direction of polarizing plates placed at the upper part of the liquid crystal cell. Nine liquid crystal cells measured under such placement were found to be substantially consistent in voltage-transmittance curves. This showed that the alignment film in the present invention provided the liquid crystals with a uniform inclination azimuth regardless of the positions in the substrate holder.

The alignment film was formed on a high-doped silicon substrate under the same conditions for the liquid crystal cells described above, and the film surface was observed with a scanning electron microscope and an atomic force microscope. In the observation with the scanning electron microscope, the surface of the alignment film was very uniform and such particles as to indicate adhesion of droplets were not seen to be present. From the observation results with the atomic force microscope, the alignment film formed by the manufacturing process of the present invention was proved to have extremely higher surface smoothness than alignment films formed by the conventional deposition method, and its surface roughness was found to be 0.18 nm in terms of the RMS (root mean square) value. This value was less than ⅕ of the RMS value of a film formed by the electron beam deposition method at the same deposition angle.

### EXAMPLE 2

In this Example, the inorganic alignment film was formed on glass substrates, using a cathode material different from that in Example 1. The same vacuum arc plasma film forming system as in Example 1 was used.

In this Example, high-purity silicon was used as the material for the cathode 101. However, since the high-purity silicon has too high resistivity to easily generate arc discharge, silicon doped with 500 ppm of boron was used as the cathode material.

In the same way as in Example 1, oxygen was fed into the film forming chamber 114 through the gas feed valve 111 so as to form an inorganic alignment film composed of silicon oxide. The flow rate of this oxygen was appropriately controlled to make an experiment.

The discharge voltage for vacuum arc discharge was set at 30 V, and the arc current at 70 A. Substrates, the arrangement of the substrates at the time of film formation, degree of vacuum, and conditions for beam scanning by the aid of a magnetic field were in consistency with those in Example 1.

The film formation was carried out for 30 minutes, and thereafter the substrates with films formed thereon were taken out of the system. From observation of the cross section of the film with a scanning electron microscope, its thickness was found to be 20 nm. The rate of film formation was 40 nm/min.

The flow rate of oxygen was changed from 0 sccm to 10 sccm to form films to make a comparison. All the films formed at a flow rate of less than 7 sccm looked yellowish. This was because the silicon was not sufficiently oxidized and was formed into metallic silicon films which were colored.

Transparent films formed at flow rates of from 7 sccm to 10 sccm were stoichiometrically analyzed in the following way.

FIG. 10 shows the results of analysis by XPS (X-ray photoelectron spectroscopy), and shows spectra in the vicinity of binding energy of 2 p electrons of silicon. The ordinate represents the photoelectron detection intensity (arbitrary scale) and the abscissa represents the binding energy. The plots shown by two dotted lines represent SiO₂ and SiO spectra, and the plots shown by solid lines represent the spectra of the films measured. Any film is mostly composed of SiO₂, where the SiO component somewhat decreases with an increase in the flow rate of oxygen.

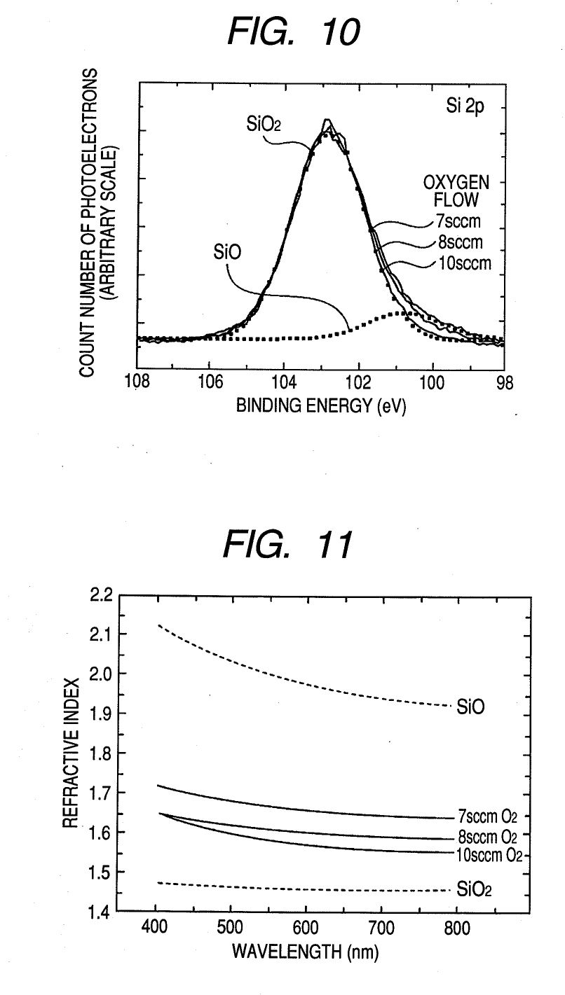

FIG. 11 shows the measurement results of the wavelength dependence of refractive indexes. The dotted lines represent the refractive indexes of SiO (the upper line) and SiO₂ (the lower line), and the solid lines represent the refractive indexes of the films measured. It is ascertained that the proportion of SiO₂ gradually increases with an increase in the flow rate of oxygen. The results of XPS show that the films are mostly composed of SiO₂, whereas, when viewed from the refractive index, the SiO component seems to be considerably contained.

Two substrates with the alignment films thus formed thereon were placed face to face so that the directions of bombardment with the plasma beam were antiparallel to each other. Then, these two substrates were joined together interposing therebetween a Mylar film of 1 mm in width, 20 mm in length and 12.0 microns in thickness as a spacer, to prepare a hollow cell.

Using substrates with the same alignment films as in the above formed thereon, a liquid crystal cell of 10 μm in cell thickness was prepared, and the pretilt angle was measured by the method shown in FIG. 7, and found to be +5.5°. As with Example 1, the liquid crystal molecules were inclined in the azimuth 180° opposite to the azimuth of the plasma beam.

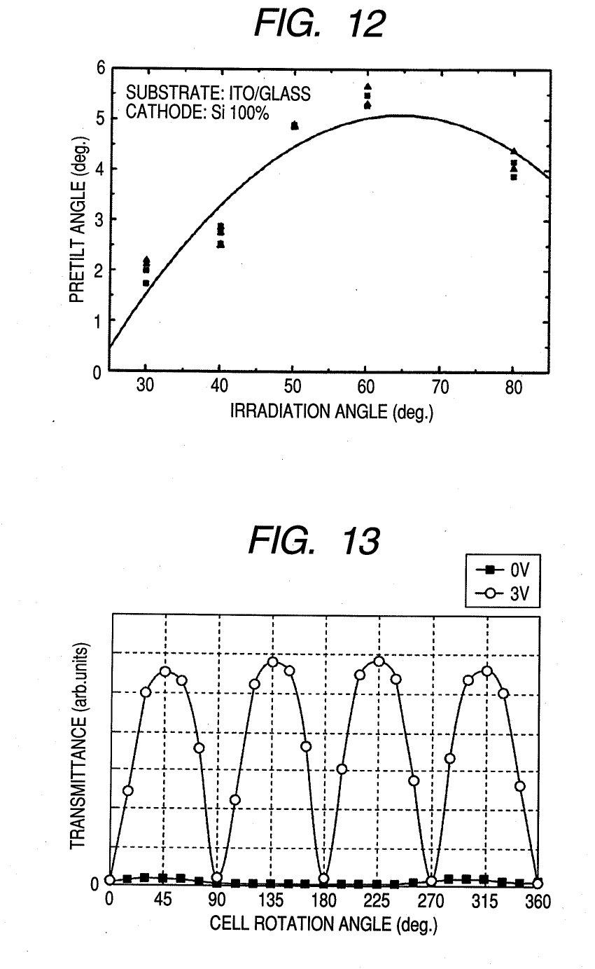

FIG. 12 shows pretilt angles with respect to plasma bombardment angles.

The pretilt angle increases with an increase in the plasma bombardment angle when the bombardment angle is small, but becomes maximum when the bombardment angle is about 40°0 in the plus direction or about 60° in the minus direction, and the pretilt angle decreases when the bombardment angle is larger than that.

From this fact, it is understandable that a substantially constant pretilt angle is obtainable even when the bombardment angle varies in the range of several degrees to ten degrees.

Into the hollow cell obtained above, a liquid crystal material (MLC-6608, available from Merck & Co., Inc) was injected by utilizing capillarity in the atmosphere to obtain a liquid crystal cell. This liquid crystal exhibits substantially vertical alignment on a conventional silica oblique deposition film.

When the liquid crystal cell was placed in parallel with a polarizing plate and was observed from the substrate normal direction, it was found to hardly transmit light without regard to the azimuth of placement of the liquid crystal cell. Thus, the liquid crystal molecules were seen to be aligned substantially vertically to the substrate. Faulty alignment was not observed by the naked eye. Microscopic observation was further made to reveal that a uniform state of alignment was achieved even in minute regions.

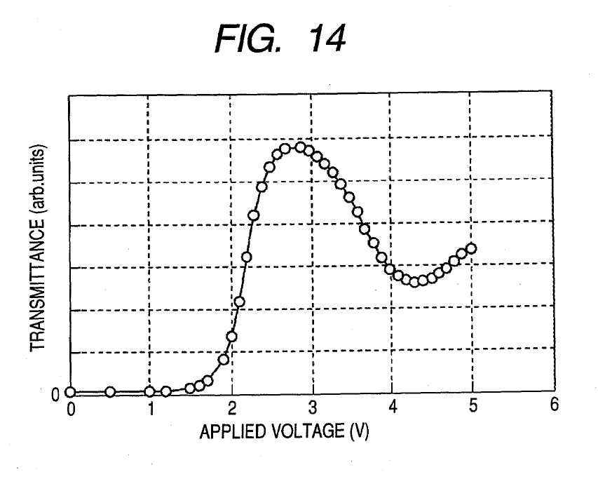

Lead wires were attached to the upper and lower electrodes of the liquid crystal cell, and this was placed between two polarizing plates disposed in the state of crossed Nicols, to make an observation. Changes in transmittance which were observed when the azimuth of placement of the liquid crystal cell was rotated are shown in FIG. 13. In FIG. 13, black squares indicate the transmittance measured when no voltage is applied; and white circles, when a voltage of 3 V is applied. On the abscissa, the azimuth of the plasma beam at the time of film formation is set to be 0°.

Since the pretilt angle is as small as 5.5°, the light is scarcely transmitted without regard to the azimuth of placement of the liquid crystal cell when no voltage is applied.

When voltage is applied, the transmittance is 0 at the places where the azimuth of the plasma beam is in agreement with the absorption axis of the polarizing plates and at the azimuths at right angles therewith, and the transmittance increases at the azimuths other than the above azimuths. The liquid crystal molecules are aligned in parallel with the direction of bombardment with the plasma beam. From the fact that good extinction has been achieved, the scattering of inclination directions is proved to be small.

Setting at 45° the angle formed by the axis of the polarizing plates and the inclination azimuth of liquid crystal molecules, the dependence of transmittance on applied voltage was examined to obtain the results shown in FIG. 14. It is understood that the transmittance rises at about 1.5 V and increases monotonously up to about 3 V. It is understandable from this fact that the liquid crystal molecules are inclined in accordance with applied voltage while keeping the inclination azimuth from an inclined state when no voltage is applied, i.e., toward the azimuth of 180° with respect to the inclination azimuth of liquid crystal molecules.

Simulation of the relationship between voltage and transmittance by calculation has indicated that similar voltage-transmittance characteristics are brought out when the pretilt angle is 5° to 6°. This is substantially in consistency with the pretilt angle measured.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2006-332173, filed Dec. 12, 2006, which is hereby incorporated by reference herein in its entirety.

1. A manufacturing method of a liquid crystal optical device comprising:
an alignment film forming step of forming an alignment film containing silicon oxide on a substrate, and a liquid crystal cell forming step of disposing a pair of substrates, at least one of which the alignment film has been formed on, opposite to each other interposing a liquid crystal therebetween, wherein
the alignment film forming step comprises a step of generating a plasma beam by vacuum arc discharge using a material containing silicon as a cathode, an a step of bombarding with the plasma beam a surface of the substrate which is disposed on a course of the plasma beam obliquely with an angle; and
in the step of bombarding the surface of the substrate, plasma ions in the plasma beam have higher kinetic energy or higher flux density than plasma ions in a plasma beam which, if bombarding the substrate obliquely with the angle, form a film having a column structure.

2. The manufacturing method according to claim 1, wherein the step of bombarding the surface of the substrate with the plasma beam is carried out in the presence of oxygen gas.

3. The manufacturing method according to claim 1, wherein the alignment film forming step is carried out while the substrate are scanned with the plasma beam.

4. The manufacturing method according to claim 1, wherein
the alignment film has been formed on both of the pair of substrates, and the pair of substrates are disposed opposite to each other so that directions in which the surfaces of the substrates have been bombarded with the plasma beam are antiparallel to each other.

5. The manufacturing method according to claim 1, further comprising a step of cutting the substrates after the liquid crystal cell forming step.

6. The manufacturing method according to claim 1, wherein the material used as the cathode is silicon.

7. The manufacturing method according to claim 1, wherein the material used as the cathode is an alloy of silicon and aluminum.
